(19) United States
(12) Patent Application Publication
(10) Pub. No.: US 2024/0299242 A1
(43) Pub. Date: Sep. 12, 2024

(54) SYSTEM AND METHOD FOR MASSAGE DEVICE

(71) Applicant: Jackson C. Harris, Playa Del Rey, CA (US)

(72) Inventor: Jackson C. Harris, Playa Del Rey, CA (US)

(21) Appl. No.: 18/595,884

(22) Filed: Mar. 5, 2024

Related U.S. Application Data
(60) Provisional application No. 63/450,310, filed on Mar. 6, 2023.

(51) Int. Cl. A61H 23/00; A61H 23/02

(52) U.S. Cl. CPC A61H 23/006; A61H 23/0263; A61H 2201/0107; A61H 2201/0153; A61H 2201/0157; A61H 2201/0161; A61H 2201/0192; A61H 2201/0207; A61H 2201/0214; A61H 2201/1215; A61H 2201/1418; A61H 2201/1611; A61H 2201/1614; A61H 2201/1626; A61H 2201/1664; A61H 2201/5007; A61H 2205/062; A61H 2205/081

(57) ABSTRACT

A system and method for a massage device that will allow a single user to operate a massage gun and/or receive electromechanical massage on the user's back without having to reach backwards, sideways, or twisting, thus keeping their spine aligned. The massage device may have a series of handles for gripping and the motor system may be positioned closer to the massage head allowing the user to easily grasp the device.

### CROSS REFERENCE TO RELATED APPLICATIONS

This application claims priority to U.S. Provisional Patent Application No. 63/450,310 filed on Mar. 6, 2023.

### FIELD OF DISCLOSURE

The overall field of this invention is directed to a massage device and more particularly a modular massage device with different customizations that allows the user to provide massage relief to their back, neck, and shoulders while keeping their spine aligned.

### BACKGROUND

Percussion therapy has grown increasingly popular in recent years and many American households now are home to a portable massage gun. A standard gun typically consists of three main parts: a rechargeable battery, body, and interchangeable tip attachments. An internal DC motor and a slider-crank mechanism is used to produce a reciprocating motion in the tip of the gun which is placed into contact with the user's body. Users derive many benefits from the high frequency percussion of a massage gun: improved mobility, reduced soreness after exercise, and decreased delayed onset muscle soreness. Percussion therapy also has many applications and is used in many different contexts. Massage guns are used by athletes, sedentary people, people struggling with diseases that affect their musculature, the elderly, and in physical therapy.

While the handheld massage gun allows for great control and mobility to the front of the body, it provides limited maneuverability to the back and lower extremities. This is due to the mobility limitations of the wrist and arm. The wrist must be oriented in such a way that the massage shaft is normal to the body. This means that the back and other hard to reach areas are left totally unavailable by conventional massage guns. There are solutions that allow for such access but it does not have a percussive element. Currently in the market, there is no percussion therapy product that can access these hard-to-reach areas and provide adequate pressure and have their controls readily accessible by the user. The goal of this project is to design and develop a modular vibrational massage device that is both far-reaching and powerful to perform exceptional massages every time without the need of uncomfortable stretching.

### SUMMARY

The physical capabilities of massage gun technology do not allow for use on one's own back, neck, and shoulders. By combining massage gun technology with cane shaped back massagers or other extensions, the present invention provides relief to the back, neck, and shoulders that neither product can achieve on their own. The present invention will allow a single user to operate a massage gun and/or receive electromechanical massage on the user's back without having to reach backwards, sideways, or twisting. Instead, the present invention will allow massaging using a comfortable forward facing handheld motion by combining handheld massage guns and canes into a new apparatus. The massage device in the present invention allows for the user to pinpoint exactly where their pain resides. When using a massage gun on your back, you are twisting your body and are further misaligning your spine. Injury may occur from straining your body to reach the target area while using a massage gun. With the massage device, the user maintains proper spinal alignment, thus allowing deeper relief by not straining/misaligning the muscles around the target area. By combining percussive therapy with hand held cane shaped back massagers an evolution in massage device technology has occurred. The massage device returns power to those in pain who cannot afford to repeatedly get massages, go to the chiropractor, or pursue alternative methods of healing.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates a first embodiment of the massage device.

FIG. 2 illustrates a second embodiment of the massage device.

FIG. 3 illustrates a third embodiment of the massage device.

FIG. 4 illustrates a fourth embodiment of the massage device.

FIG. 5 illustrates a fifth embodiment of the massage device.

FIG. 6 illustrates the adjustment holes of the massage device.

FIG. 7 illustrates one embodiment of the motor.

FIG. 8 illustrates another embodiment of the motor.

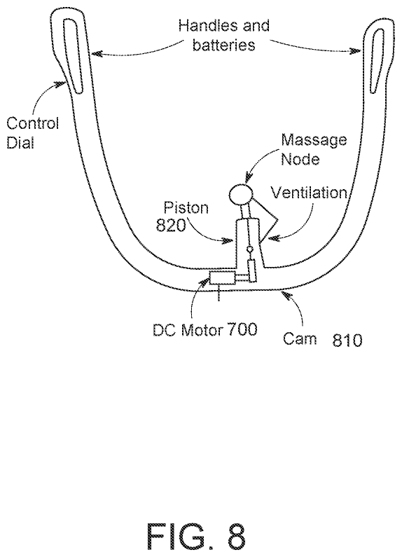

### DETAILED DESCRIPTION

In the Summary above and in this Detailed Description, and the claims below, and in the accompanying drawings, reference is made to particular features of the invention. It is to be understood that the disclosure of the invention in this specification includes only some of the possible combinations of such particular features.

Where reference is made herein to a method comprising two or more defined steps, the defined steps may be carried out in any order or simultaneously (except where the context excludes that possibility), and the method can include one or more other steps which are carried out before any of the defined steps, between two of the defined steps, or after all the defined steps (except where the context excludes that possibility). In the following detailed description, numerous specific details are set forth in order to provide a more thorough understanding of the one or more embodiments described herein. However, it will be apparent to one of ordinary skills in the art that the invention may be practiced without these specific details. In other instances, well-known features have not been described in detail to avoid unnecessarily complicating the description.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

The present invention includes a percussive device mounted on the contact point of a cane shaped back massager. Users can adjust and alternate their handle placements allowing for customizable access to areas of muscle previously unreachable. The main pieces of the massage device will be able to be twist-and-screwed or snap-and-locked together. The length may come in varying heights specifically tailored for the user. In addition to having smaller and larger models outside of the base model, the massage device will have a sliding base allowing for shortening/lengthening to properly fit the size of the user.

The massage device will be able to be deconstructed into multiple pieces (including the massage gun) so that it may be able to fit in a carry-on sized travel bag. The percussive device/massage gun will be able to be removed and used as a massage gun on its own, or may be permanently attached in special massage device versions. The cane shaped back massager will have one or more plastic knobs or other attachments that will be able to screw into the contact point so the massage device can be used as a simple non-powered back massager as well. The massage device may be produced with hollow or solid shafts. The ability to be deconstructed and quickly put back together by both user and producer serves as a great benefit in repair. Should a specific mechanism fail, users will be able to have a replacement part shipped to them rather than having the entire device shipped back and forth.

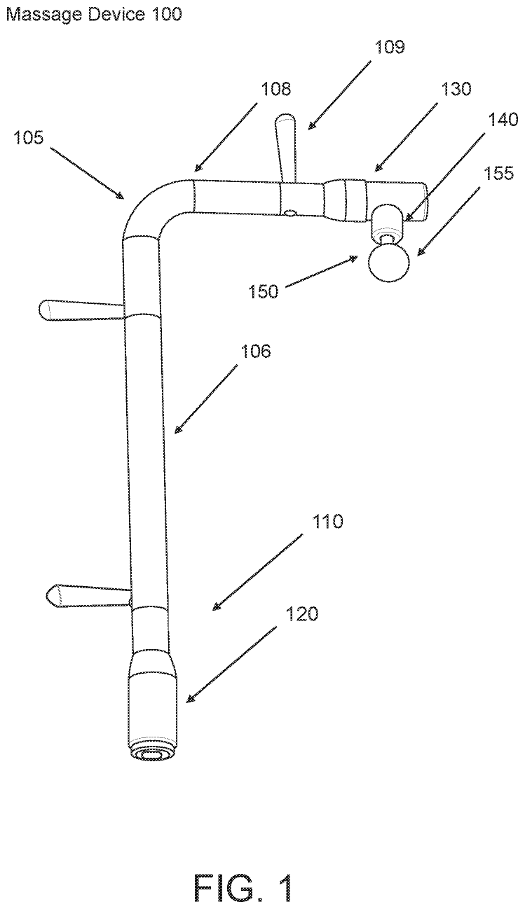

FIG. 1 depicts a side view of one embodiment of a massage device 100. Massage device 100 may include a housing 105, a power system 110, a control system 120, a motor system 130, and an actuated output 140.

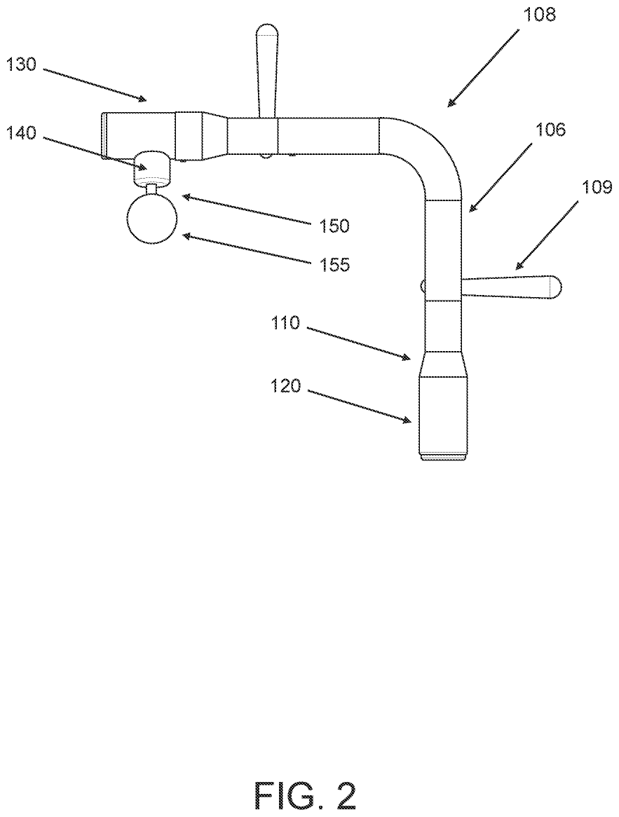

Housing 105 is a structure allowing for connection of one or more other components of massage device 100 and may vary in length and size depending on the need and use. Housing 105 completely or substantially encloses one or more other components. As illustrated in FIG. 1, housing 105 may have a cane shape with a first component or vertical component 106 and second component or horizontal component 108 connected at a bend whereby the vertical component 106 is longer than horizontal component 108. As illustrated in FIG. 2, housing 105 may have a smaller cane with a switched out smaller vertical component whereby vertical component 106 and horizontal component 108 are connected at a bend whereby the vertical component 106 is equal in length to horizontal component 108.

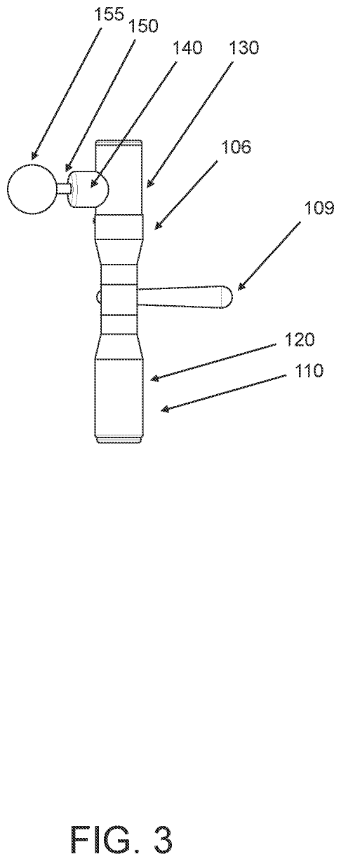

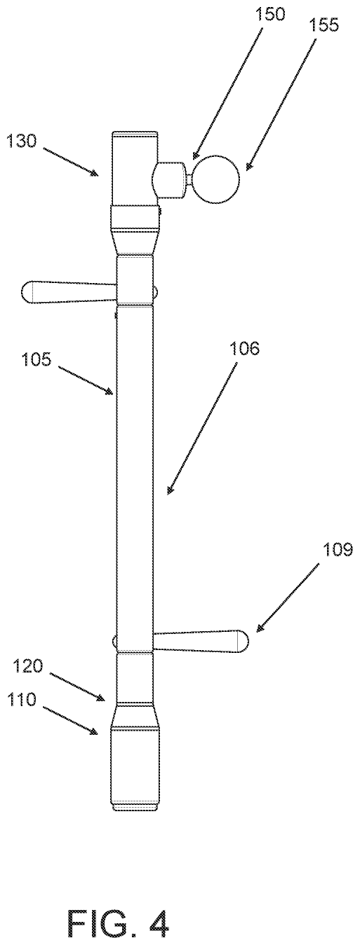

As illustrated in FIG. 3. housing 105 may have an elongated shaft shape with one first component or vertical component 106. As illustrated in FIG. 4, housing 105 may have a longer shaft shape with a switched out longer vertical component 106.

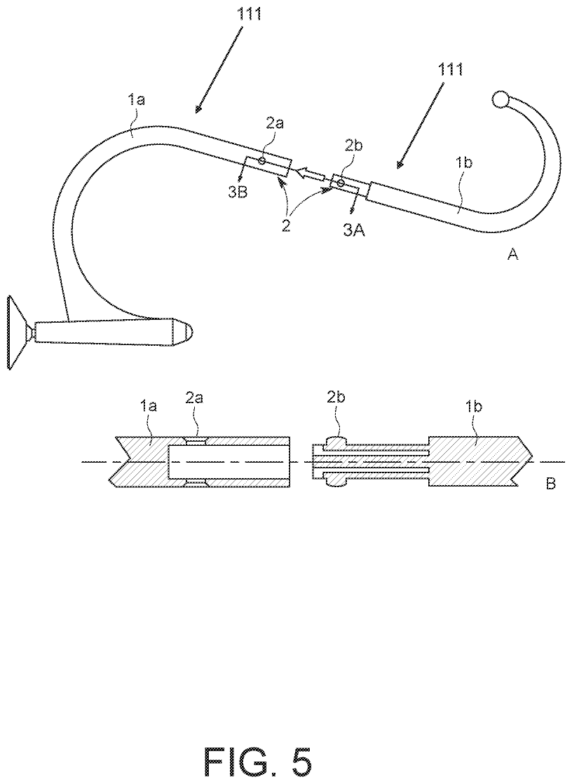

In further embodiments, as illustrated in FIG. 5, massage device 100 may have a vertical component 106 and a curved component 111 attached at a distal end of vertical component 106 or two curved components 111 connected to one another. The vertical components and horizontal components may be hollow shafts to allow the circuitry to pass through inside the components.

In some non-limiting embodiments, horizontal component 108 may be a gooseneck arm. The gooseneck arm may be a spring made of a high-strength steel to provide strength and flexibility and soft galvanized iron wire that is compressed into the gaps of the spring to provide stiffness to massage device's 100 position. As such, the user manipulates horizontal component 108 to the location chosen, thereby securing massage device 100 in place

The modular components of housing 105 may be connected by a twist locking system and have one or more electrical connectors that are used to transmit power and electrical signals between the main device and the modular component, as illustrated in FIG. 5. In this twist locking system, la connects to 1b whereby portion 3a is positioned inside of portion 3b with a push button mechanism 2b received into hole 2a. This allows the battery and user interface be positioned at a bottom front of the device which would be in front of the user during use while the motor system may be positioned in the back which would be behind the user in use. This allows the user to interact with the controls in front of them while receiving a massage on their back. However, this is non-limiting and these components may be placed anywhere on the device such as having the control panel and battery placed on the middle of the vertical component.

The connectors may include pin-and-socket connectors, USB connectors, or proprietary connectors designed specifically for massage device 100. Modular components may have standard communication protocols and auto-detection features built into the components software. To safeguard against electrical faults, short circuits, or overcurrent conditions, the modular devices may include circuit protection mechanisms such as but not limited to fuses, circuit breakers, or current limiters.

Housing 105 may include one or more handles 109. Handles 109 defines a handle axis that runs substantially perpendicular and on opposing sides of vertical component 106, as illustrated in the shaft shape variants of FIG. 3 and FIG. 4. Two handles 109 may be positioned perpendicular and on opposing sides of vertical component 106 with an additional handle 109 connected to horizontal component 108 that is perpendicular to the other handles, as illustrated in the cane shape variant of FIG. 1. One handle 109 may be positioned perpendicular to vertical component 106 with an additional handle 109 connected to horizontal component 108 that is perpendicular to the first handle, as illustrated in the cane shape variant of FIG. 2.

In some embodiments, handle 109 may be straight or substantially straight along its longest dimension, and the handle axis runs through the center or substantially through the center of handle 109. In another embodiment, handle 109 may be curved along its longest dimension, and the handle axis is tangent to the curvature of handle 109 at the midpoint of handle 109. Handle 109 may have one or more surfaces that are shaped so that it can be ergonomically gripped by a user's palm.

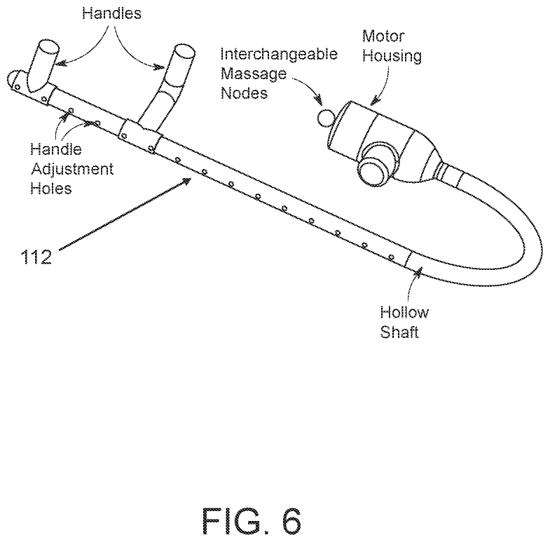

Handles 109 may be connected to housing 105 by one or more adjustment holes 112 that are added on the vertical component 106 which allow the user to adjust position and orientation of the handles to fit their body size, as illustrated in FIG. 6. Pins may be attached on handles 109 to easily fix its position. Second, the orientation of the handles is changed to be vertical to the hollow shaft instead of the original horizontal placement. This configuration makes it easier for a user to support the weight of the product body.

Power system 110 may be designed to provide energy to the circuits and components of massage device 100 during the process of operating massage device 100. Massage device 100 may be powered by methods known by those of ordinary skill in the art such as a USB-A or USB-C charging port for the electrochemical cell. In some embodiments, massage device 100 may plug into an electrical outlet using an electrical cord to supply power to the circuits and components of massage device 100. Further, the power system 110 may include a rechargeable battery pack whereby the rechargeable battery is of a charge, design, and capacity to provide sufficient power to the circuits and components of massage device 100 during operation for a set period of time needed to interact with massage device 100.

The battery may be any type of battery known in the art. For example, the battery may include a rechargeable lithium-ion (Li-Ion) based battery. In another example, the battery may include a rechargeable nickel metal hydride (NiMH) battery. In yet another example, the battery may include a rechargeable lithium-polymer (LiPo) battery. In some embodiments, the battery includes a nickel-cadmium (NiCad) battery. In one embodiment, the battery uses a non-rechargeable battery.

Massage device 100 may have a control system 120 or electronic control unit to control the actuation of the other systems. Control system 120 may have a series of computing devices which will be discussed in detail later in the description. Control system 120 may be in the form of a circuit board, a memory, or other non-transient storage medium in which computer-readable coded instructions are stored and one or more processors configured to execute the instructions stored in the memory. Control system 120 may have a wireless transmitter, a wireless receiver, and a related computer process executing on the processors, whereby the electronic control unit modulates a frequency and intensity of the one or more vibrating motors including a wireless radio or Bluetooth radio/receiver to interface with a remote control hardware device or software application. The vibrating motors may have one or more motors including an electric motor with an unbalanced mass on its driveshaft.

Computing devices of control system 120, may be any type of computing device that typically operates under the control of one or more operating systems, which control scheduling of tasks and access to system resources. Computing devices may be a Raspberry Pi® or other computing devices such as but not limited to a phone, tablet, television, desktop computer, laptop computer, networked router, networked switch, networked, bridge, or any computing device capable of executing instructions with sufficient processor power and memory capacity to perform operations of control system 120.

The one or more computing devices may be integrated into control system 120, while in other non-limiting embodiments, control system 120 may be a remotely located computing device or server configured to communicate with one or more other control systems. Control system 120 may also include an internet connection, network connection, and/or other wired or wireless means of communication (e.g., LAN, etc.) to interact with other components. The connection allows a user to update, control, send/retrieve information, monitor or otherwise interact passively or actively with control system 120.

Control system 120 may include circuitry to provide an actuable interface for user 101 to interact with, including switches and indicators and accompanying circuitry for an electronic control panel or mechanical control panel. Such an actuable interface may present options to user 101 to select from what would allow user 101 to control motor system 130 including but not limited to power, speed, and temperature. Control system 120 may be preprogrammed with any reference values by any combination of hardwiring, software, and firmware to implement various operational modes.

The microprocessors in control system 120 may also monitor the current state of circuitry within control system 120 to determine the specific mode of operation chosen by the user. Further, such microprocessors that may be part of control system 120 may receive signals from any of or all systems, including without limitation, motor system 130 and power system 110. Such systems may be notified whether any of the components in the various systems need to be replaced.

Control system 120 may be connected to a switch which controls delivery of power to motor system 130. The switch may be an electrical switch configured to allow passage of electric current when activated. In some embodiments, the switch is a binary on/off switch. In another embodiment, the switch is a variable switch. A variable switch controls the amount of power delivered to motor system 130. A relatively high amount of power delivered to motor system 130 by the variable switch results in an increased speed of the motor of motor system 130. A relatively low amount of power delivered to the motor by the variable switch results in a decreased speed of the motor. In one embodiment, the variable switch includes a variable resistor that allows a progressively increased amount of power to flow to the motor in response to a progressively increasing activation of that switch.

In certain embodiments, the switch includes multiple positions. For example, the switch may include an off position, a first activated position, and a second activated position. The switch may include one or more positions in which without additional user input, the switch remains in that position, and one or more positions in which without additional user input, the switch is biased to exit that position.

Control system 120 may have an automatic shut off timer for a fixed or user-adjustable time to prevent over massaging an area and overheating massage device 100. Massage device 100 may also be a heat sensor that sends a signal to control system 120 to shut off massage device 100 if it exceeds thermal capacity.

Massage device 100 may have a motor system 130 within the housing of massage device 100 positioned near actuated output 140 such that when the user uses massage device 100, the battery and controls are in the bottom front for better weight distribution and control of movement. Motor system 130 may be modular and removable, operating as a smaller massage gun when removed from the remainder of massage device 100.

Motor system 130 converts power from the power source 110 into motion. In some embodiments, motor system 130 may include an electric motor 700. Motor 700 may be any type of electric motor known in the art, including, but not limited to, a brushed motor, a brushless motor, a direct current (DC) motor, an alternating current (AC) motor, a mechanical-commutator motor, an electronic commutator motor, or an externally commutated motor. Motor housing may be designed to be removable so that massaging the front of the body is more convenient in a gun format.

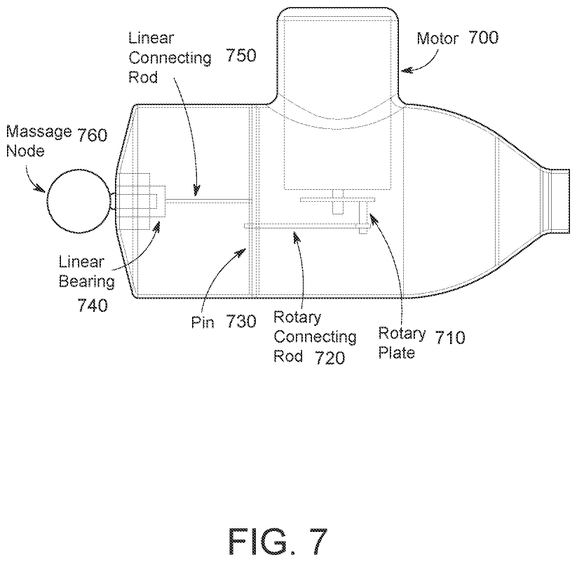

Motor 700 may produce rotary motion. The rotary motion delivered by the motor may be delivered through a shaft. The shaft may rotate around a shaft axis. Motor 700 may be connected to a mechanism that converts the rotational motion of the motor into linear, reciprocating motion such as by a rotary plate 710, rotary connecting rod 720, a pin 730, a linear connecting rod 750, and a linear bearing 740, as illustrated in FIG. 7. As motor 700 spins, it drives this mechanism to move back and forth rapidly. The reciprocating motion is transferred to actuated output 140 whereby actuated output 140 is designed to move in a rapid, pulsating manner.

In further embodiments, motor system 130 may provide a rotating motion using a mechanism supplied by a cam 810 on a rotating shaft connected to a piston 820, with horseshoe-like geometry. In other embodiments, motor system 130 may have one or more motors including an electric motor with an unbalanced mass on its driveshaft. Mechanical vibration may help reduce unidirectional stress built in fascia protein fibers, improve ground substance molecular diffusion, and restore fascia viscosity. Motor system 130 may receive power from power system 110, which as discussed can be a battery. When activated, the electrical power flows through the motor's windings. The flow of electricity through the motor's windings generates a magnetic field.

This magnetic field interacts with the magnetic fields in the motor or the electromagnetic fields generated by other coils. This interaction of magnetic fields causes the motor's shaft to rotate. As the shaft rotates, the eccentric weight, which is not centered on the shaft, creates a centrifugal force as it spins, creating a wobbling effect. This wobbling effect due to the unbalanced mass translates into vibrations. The speed of the motor (and hence the frequency of vibration) and the amount of unbalance (which affects the amplitude of the vibration) can be varied to create different vibration effects. These vibrations are then transmitted to actuated output 140, whereby actuated output 140 is designed to vibrate.

Massage device 100 may include an attachment 150 that may be an interchangeable, user selectable component that is connectable to the actuated output 140. The attachment 150 may include a massage node 155 designed to interact with a patient such that the motion from actuated output 140 is translated to massage node 155. Massage node 155 may be in the shape of a sphere or any desired shape the user wishes to have interact with their body. In further embodiments, there may be multiple massage nodes 155 in use at the same time. They may be stacked upon or otherwise connected to one another for farther reach whereby massage nodes 155 may have a bottom portion and a top surface portion whereby the top surface portion may be of equal or smaller circumference than bottom surface portion to allow for stacking.

In some embodiments, the actuated output 140 may include a connector for connection of an attachment different from attachment 150. Other attachments may be added to massage device 100, including different types of massage guns (e.g., rotating in addition to pulsating), heating elements/pads for pinpoint heat delivery, cooling elements for cooling areas in the back, etc. For instance, attachment 150 may have one or more electric heating elements connected to power system 110. These elements consist of a material with high electrical resistance, such as nichrome wire, which heats up when an electric current passes through it. Attachment 150 may have one or more thermoelectric coolers connected to power system 110 whereby an electric current is used to create a temperature difference, effectively chilling or heating one part of the device that comes into contact with the skin.

In some embodiments, the actuated output 140 includes a securing mechanism for securing an attachment in the connection socket. The connector may be any type of structure capable of retaining an attachment, such as a socket with a latch, a threaded connector, or the like. For example, the securing mechanism may include a biased structure, such as a spring, to bias the securing mechanism toward a locked position. In the locked position, the securing mechanism may restrict removal of an attachment. The biased structure may be articulated by a user to move the securing mechanism toward an unlocked position. In the unlocked position, the securing mechanism may allow removal of an attachment. In some embodiments, the securing mechanism includes a keyway to interact with a key on an attachment. The keyway may be selectively opened and closed by articulation of the securing mechanism. Removal of an attachment may be restricted in response to the keyway being closed.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A massage device comprising, a housing, a motor, an actuated output operatively connected to the motor and configured to reciprocate in response to activation of the motor, and a massage node operatively connected to the actuated output.

2. The massage device of claim 1, wherein the massage device has a vertical component and a horizontal component forming a cane shape, wherein the vertical component has a battery and a control interface, wherein the horizontal component has the motor.

3. The massage device of claim 2, wherein the massage device is modular.

4. The massage device of claim 3, wherein the vertical component has a replaceable component to extend a length of the massage device.

5. The massage device of claim 2, wherein the vertical component has a first handle perpendicular to the vertical component.

6. The massage device of claim 5, wherein the vertical component has a second handle opposite of the first handle and perpendicular to the vertical component.

7. The massage device of claim 6, wherein the vertical component has one or more adjustment holes for altering a length.

8. The massage device of claim 2, wherein the actuated output has a connector for connecting different attachments.

9. The massage device of claim 8, wherein the massage node is a sphere.

10. The massage device of claim 8, wherein the massage node is a heating device.

11. The massage device of claim 8, wherein the massage node is a cooling device.

12. The massage device of claim 1, wherein the massage device has two curved components on opposing sides.

13. A massage device comprising, a housing, a user control, a motor, an actuated output operatively connected to the motor and configured to reciprocate in response to activation of the motor, and a massage node operatively connected to the actuated output, wherein the user control is on a first component and the motor is on a second separate component that is connectable to the first component and on opposite ends of the massage device.

14. The massage device of claim 13, wherein the first component has a handle.

15. The massage device of claim 13, wherein the second component has a second handle.
